(19) United States
(12) Patent Application Publication
(10) Pub. No.: US 2005/0289566 A1
(43) Pub. Date: Dec. 29, 2005

(54) Fitting structure for tray rails of optical disc drive

(75) Inventor: Wu-Jen Lo, Taipei City (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: LITE-ON IT Corporation, Taipei City (TW)

(21) Appl. No.: 11/167,841

(22) Filed: Jun. 27, 2005

(30) Foreign Application Priority Data
Jun. 29, 2004 (TW) 093119175

(51) Int. Cl. G11B 17/03

(52) U.S. Cl. 720/600

(57) ABSTRACT

A guide rail fitting structure for optical disc drive includes rails formed on the tray and several guide poles formed on the base. At least a supporting guide pole is formed with inclines on vertical surfaces. The rails of the tray are also formed with correspondent inclines. When the tray extracts, the weight of the tray itself or also the load of a disc carried by the tray causes the tray a little lean-down. The corresponding inclines of the rail and the guide poles fit to each other so as to automatically eliminate the gap between the rail of the tray and the guide poles of the base, and prevent the tray from vibration during retraction.

### BACKGROUND OF THE INVENTION

1. Field of the Invention

The invention generally relates to fitting structure of guide rails of an optical disc drive, and in particular relates to a structure having fitting surfaces on tray rails and guide poles of the base respectively.

2. Description of Related Art

Optical disc drives have been used to read data from optical storage media. Optical discs are “the media star of tomorrow”. Disc costs less, while the capacity is large, and kinds of contents, including information, program, music, image and so on, can be stored in.

As improvements in entertainment devices for daily lives, the quality requirements for optical disc drives adopted in video players are getting more and more severe. Besides quality requirements for disc operation of the drive itself, a great attention is paid to the fluent movement (tray in and tray out) of the disc tray. Especially, the vibration problem at the moment of tray in is the first quality issue of optical disc drives.

As shown in FIG. 1 to FIG. 3B, a conventional optical disc drive includes an upper cover 110, a base 120 and a tray 130. The upper cover 110 and the base 120 are composed to form a cabinet 100 of the optical disc drive. The tray 130 having a disc carrier 132 is movably mounted inside the cabinet 100. The tray 130 retracts into and ejects from the cabinet 100 by means of more than a pair of guide rails and a correspondent structure. The guide rails and structure include rails 131 formed on the tray 130 and a plurality of guide poles 121 mounted on the base 120.

Conventionally, the tray 130 is actuated by a driving motor to retract into or eject from the optical disc drive. The driving mechanism 140 is located aside the tray 130. As a result of the driving mechanism 140 design that the driving force does not work on the center of gravity of the tray 130, in addition to a reverse friction force generated at a supporter on another side of the tray 130 that resists the tray 130 from moving when it just starts to move. It causes a torque to the tray 130. If there is no gap 150 in the horizontal direction between the rail 131 of the tray 130 and the guide poles 121 of the base 120, the torque would not influence the tray 130. However the gap 150 in fact exists to reduce the friction force and let the tray 130 movable. Therefore, before the tray 130 moving to retract or eject, the torque first revolves the tray 130 to a position to eliminate the gap 150. However, to eliminate the gap, the torque causes the tray 130 revolves and hit the restrict space in a horizontal direction, and causes the tray 130 a horizontal direction vibration. At the same time, the hit also stimulates the tray to cause a vertical direction vibration when the tray 130 is retracting into the cabinet 100 in a state of a cantilever beam.

### SUMMARY OF THE INVENTION

In view of the above conventional technical problems, the main object of the invention is to provide a tray rail fitting structure for optical disc drive. The tray rail fitting structure relates to rails of the tray and guide poles of the base. The tray rail fitting structure includes at least a rail on the tray and several guide poles on the base. When the tray is retracting into the optical disc drive, the vibration of the tray is eliminated.

In order to achieve the above object, the invention provides a tray rail fitting structure for optical disc drive. The tray rail fitting structure relates to rails of the tray and guide poles of the base. The tray rail fitting structure includes at least a rail on the tray and several guide poles on the base. At least one of the guide poles is a supporting guide pole having an incline formed on its vertical surface. The rail of the tray is also formed with correspondent incline. When the tray extracts, the weight of the tray itself or also the add-on load of a disc carried by the tray causes the tray a little lean-down. The correspondent inclines of the rail and the guide poles fit to each other so as to automatically eliminate the gap between the rail of the tray and the guide poles of the base. Since the gap between the rail of the tray and the guide poles of the base is eliminated during the tray retraction, the aforesaid vibration problem is solved.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a constructional view of a conventional optical disc drive;

FIG. 2 is a constructional view of a rail of tray in conventional optical disc drive;

FIG. 3A is a constructional view of a tray structure of conventional optical disc drive;

FIG. 3B is a detailed constructional view of a tray structure of conventional optical disc drive;

FIG. 4A is a constructional view of a fitting structure of tray rails in a first embodiment of the invention;

FIG. 4B is a detailed constructional view of a fitting structure of tray rails in a first embodiment of the invention;

FIG. 5A is a perspective view of a guide pole in the invention;

FIG. 5B is a perspective view of a guide pole of another shape in the invention;

FIG. 5C is a perspective view of a guide pole of another shape in the invention;

FIG. 5D is a perspective view of a tray of another shape in the invention;

FIG. 6A is a constructional view of a fitting structure of tray rails in a second embodiment of the invention;

FIG. 6B is a detailed constructional view of a fitting structure of tray rails in a second embodiment of the invention;

FIG. 6C is further a detailed constructional view of a fitting structure of tray rails in a second embodiment of the invention;

FIG. 7A is a constructional view of a fitting structure of tray rails in a third embodiment of the invention;

FIG. 7B is a detailed constructional view of a fitting structure of tray rails in a third embodiment of the invention; and

FIG. 7C is further a detailed constructional view of a fitting structure of tray rails in a third embodiment of the invention.

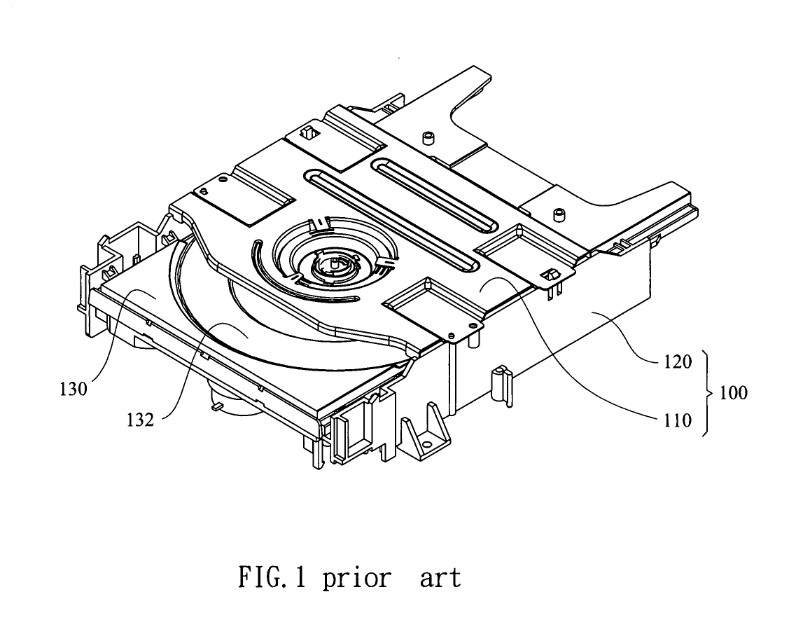

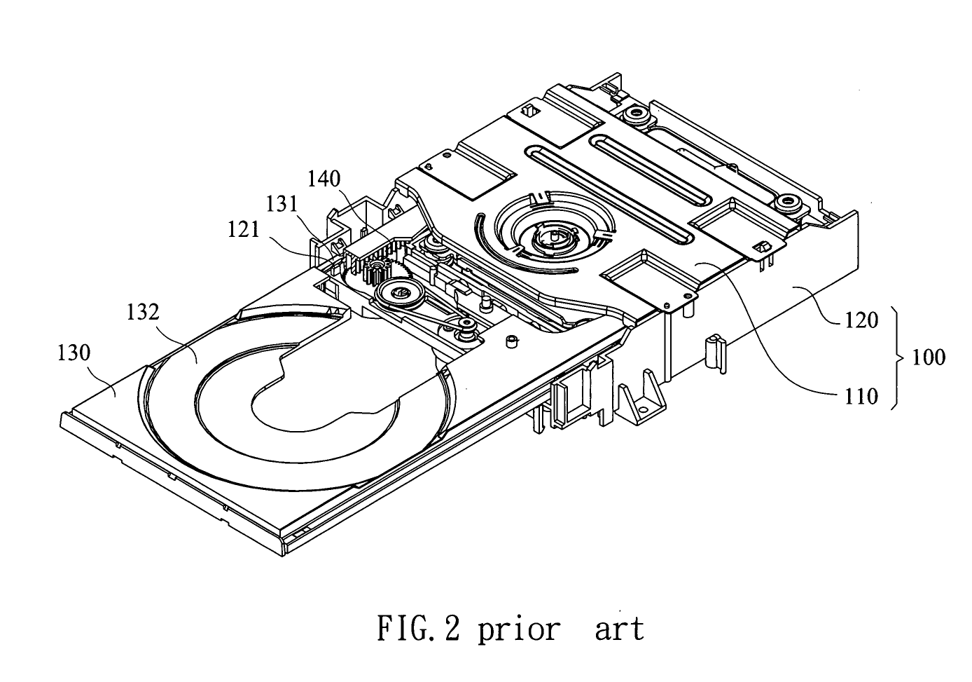

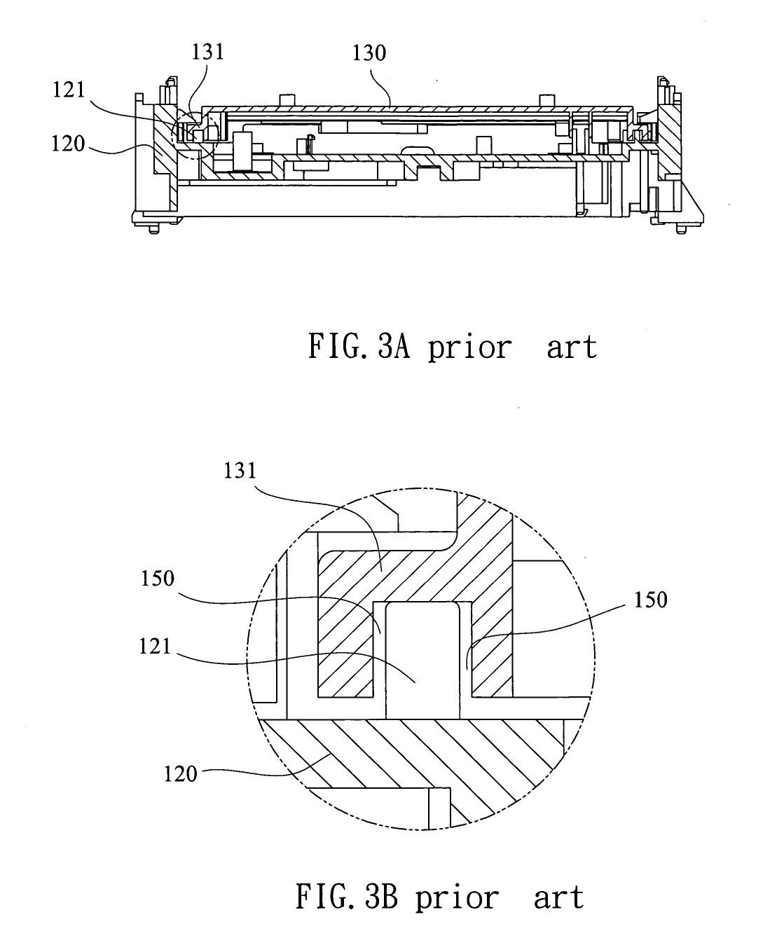

### DETAILED DESCRIPTION OF THE PREFERRED EMOBDIMENTS

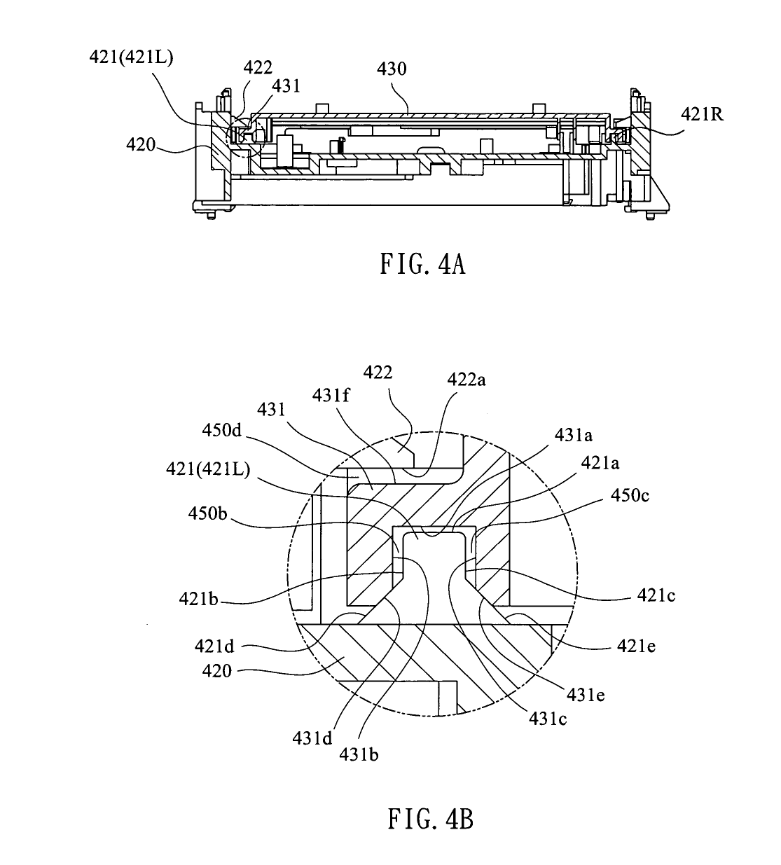

FIGS. 4A and 4B illustrate a fitting structure of tray rails for optical disc drive in a first embodiment of the invention. The optical disc drive includes an upper cover (not shown in the drawing), a base 420 and a tray 430. The tray 430 is movably mounted in the cabinet composed of the upper cover and the base 420, and capable of retracting into and ejecting from the cabinet by means of two rails. FIG. 4A illustrates a sectional view taking along the rail direction. The rail fitting structure includes a left rail 431 formed on left side of the tray 430 and a plurality of rectangular guide poles 421 formed on left side of the base 420. The interior of the left rail 431 is formed with a left vertical surface 431b and a right vertical surface 431c. The guide poles 421 are also formed with left vertical surface 421b and right vertical surface 421c. There are suitable left gaps 450b and right gaps 450c kept respectively between the left vertical surfaces 431b, 421b and the right vertical surfaces 431c, 421c of the left rail 431 and the guide poles 421.

Because the tray 430 is in an instantaneous state of cantilever beam when being retracting into the cabinet, the vibration in horizontal direction is easy to stimulate the tray 430 vibrate in vertical direction. Therefore, in order to eliminate the vibration of the tray 430 during retracting, the left gap 450b and the right gap 450c, i.e., the gaps between the left rail 431 and the rectangular guide poles 421 in the horizontal direction must be eliminated.

As shown in FIG. 4B, in order to eliminate the gap in the horizontal direction, a left-first rectangular guide pole 421L is defined in the left outer side of the base 420. The left vertical surface 421b and the right vertical surface 421c of the left-first rectangular guide pole 421L are formed with a left incline 421d and a right incline 421e respectively (the left incline 421d and a right incline 421e are also termed first inclines). The left vertical surface 431b and the right vertical surface inside the left rail 431c are also formed with a left incline 431d and a right incline 431e (the left incline 431d and a right incline 431e are also termed second inclines) corresponding to the left incline 421d and the right incline 421e of left-first rectangular guide pole 421L respectively. When the tray 430 retracts and leans down, the left incline 431d and the right incline 431e of the left rail 431 first fit with the left incline 421d and the right incline 421e of the left-first rectangular guide pole 421L. The fittings support the left rail 431 and enable a horizontal plane 431a of the left rail 431 keep a suitable gap with a horizontal plane 421a of the left-first rectangular guide pole 421L (the two horizontal planes originally contact in prior arts). Therefore, the incline fittings not only provide constraint to guide the left rail 431 with the left-first rectangular guide pole 421L in horizontal direction, but also support them in vertical direction.

The above left incline 421d and right incline 421e of fitting structure of tray rail is not limited to the left-first rectangle guide poles 421L, they can be formed on the right-first rectangle guide pole 421R of the base 420 as shown in FIG. 4. Also, the incline is not limited to a plane. It can be a curved surface or an irregular surface.

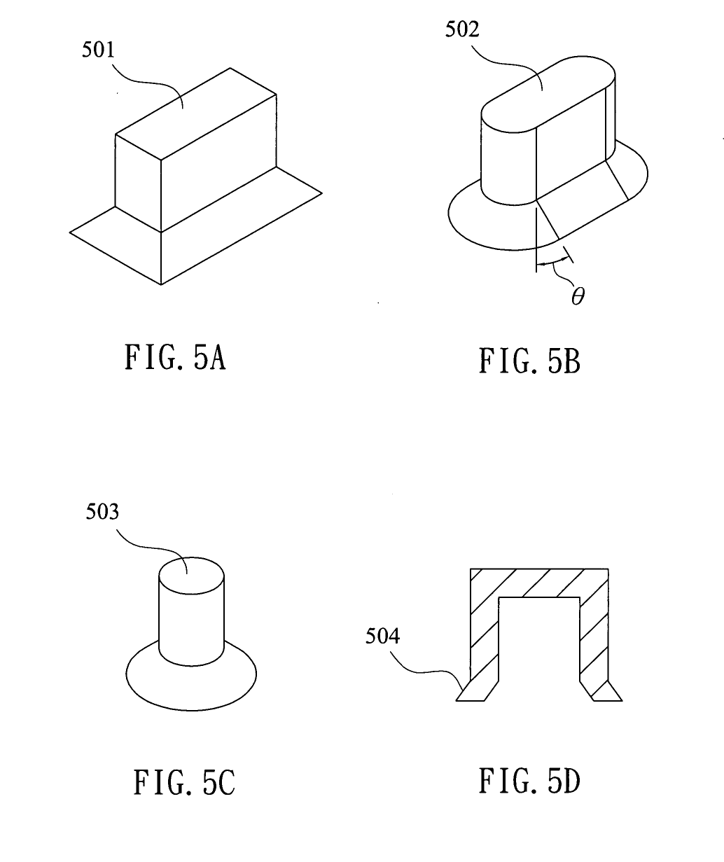

FIGS. 5A to 5D are perspective views of different embodiments of guide poles in the invention. The shape of the left-first rectangle guide pole 421L can be a rectangular column 501, an ellipse column 502 or a round column 503. The incline angle (θ) of fitting between the incline surface and the vertical surface is within 30 to 60 degrees. The left rail 431 has correspondent inward inclines, and the outer surface can be form to different shapes such as an expanded portion 504.

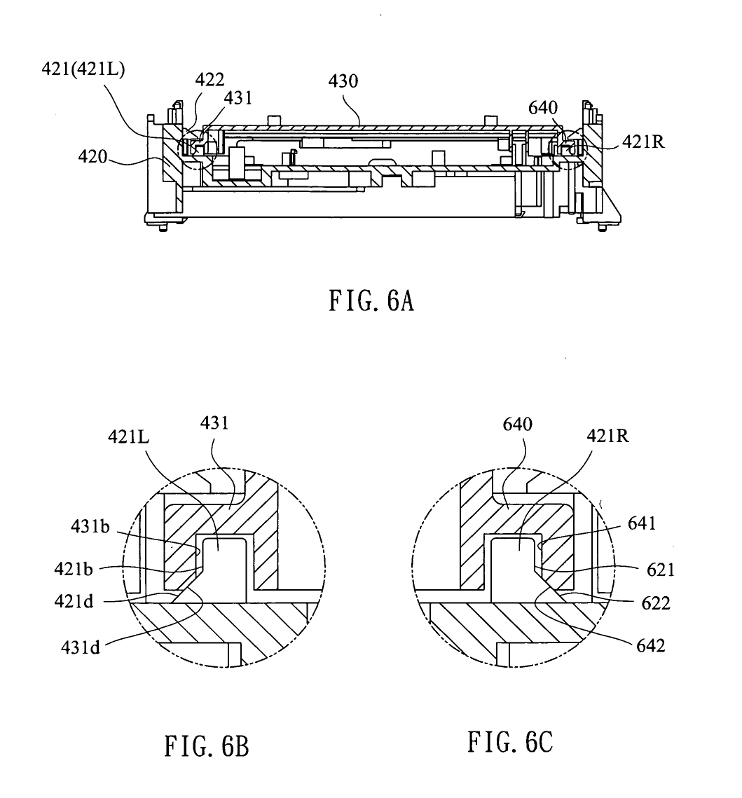

FIGS. 6A to 6C illustrate a fitting structure of tray rail of optical disc drive in a second embodiment of the invention. The horizontal constraint and support is made by a left-first rectangular guide pole 421L and a right-first rectangular guide pole 421R. The left vertical surface 421b of the left-first rectangular guide pole 421L is formed with a left incline 421d. The left vertical surface 431b inside the left rail 431 is formed with a correspondent left incline 431d. The right vertical surface 621 of the right-first rectangular guide pole 421R is formed with a right incline 622. The right vertical surface 641 inside the right rail 640 is formed with a correspondent right incline 642. When the tray 430 retracts and leans down, the left incline 431d and the right incline 431e of the left rail 431 first fit with the left incline 421d and the right incline 421e of the left-first rectangular guide pole 421L. Therefore, the fittings of the left inclines 43 id, 421d, and the right inclines 642, 622 support the left rail 431 and the right rail 640 in horizontal and vertical directions, and prevent the tray 430 from vibration.

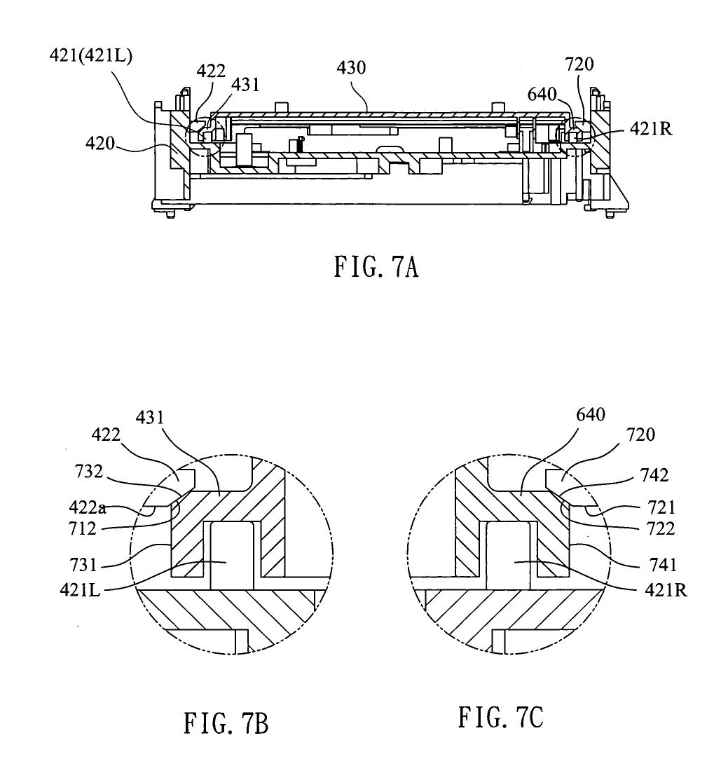

FIGS. 7A to 7C illustrate a fitting structure of tray rail of optical disc drive in a third embodiment of the invention. When the tray 430 retracts from the cabinet, the weight of the tray 430 itself or also the additive weight of a disc carried by the tray causes the tray 430 lean down a little. Therefore, a left upside stopper 422 is mounted on the base 420 and beyond the top of the left rail 431 in the glide direction with a suitable distance inward. A gap 450d (see FIG. 4B) formed between a bottom horizontal plane 422a of the stopper 422 and a top horizontal plane 431f (see FIG. 4B) of the left rail 431 limits the lean-down of the tray 430. With the same principle, relatively to the left upside stopper 422, there is a right upside stopper 720 mounted beyond the right rail 640 to attain the above effect. In other words, the embodiment separates the inclines of the guide poles into the left upside stopper 422 and the right upside stopper 720 for eliminating the gap in the horizontal direction. A left incline 712 is formed on the bottom horizontal plane 422a of the stopper 422. The left vertical outer surface 731 of the left rail 431 is formed with a correspondent left incline 732. With the same principle, a right incline 722 is formed on the bottom horizontal plane 721 of the right upside stopper 720. The right vertical outer surface 741 of the right rail 640 is formed with a correspondent right incline 742. When the tray 430 retracts from the cabinet, the left incline 732 of the left rail 431 fits with the left incline 712 of the left upside stopper 422. Simultaneously, the right incline 742 of the right rail 640 also fits with the right incline 722 of the right upside stopper 720. The two fittings support the left rail 431 and the right rail 640 in horizontal and vertical directions, and prevent the tray 430 from vibration.

The advantages of the invention are that the correspondent inclines of the guide poles and rails are easy to be manufactured. Moreover, the elimination of friction force and prevention of vibration of the tray 430 in the horizontal direction during retraction are obtained by only adjusting the angle and suitable contacted areas of the inclines. Simultaneously, without the stimulation of horizontal hit and vibration, the tray 430 is also eliminated from vibration in the vertical direction.

As described above, the fitting structure of tray rails for optical disc drive of the invention validly eliminates the tray vibration when retracting. It improves the smooth movement of the tray and makes user confide in the product. Moreover, because of the easy manufacturing of the fitting structure of optical disc drive of the invention, the cost is reduced, and the fittings can be modulated by adjusting the contact area and angle of the inclines so as to meet requirements of broad tray specifications. Therefore, it is apparent that the fitting structure of tray rail is practical.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A fitting structure of tray rail of an optical disc drive having rails to support a tray driven by a motor and a plurality of guide poles fixed on a base to guide said tray movable along said rails with a suitable gap between said guide poles and said tray, comprising:
at least a guide pole being formed with a plurality of first inclines; and
a plurality of second inclines being formed on at least one rail corresponding to said first inclines of said guide pole.

2. A fitting structure of tray rail of an optical disc drive according to claim 1 further comprises transmission mechanism on one side of said tray.

3. A fitting structure of tray rail of an optical disc drive according to claim 1 wherein said second inclines of said rail fits correspondingly to said first inclines of said guide pole.

4. A fitting structure of tray rail of an optical disc drive according to claim 1 wherein said first inclines of said guide pole and said second inclines of said rail can be of the shape of plane, curved surface, or irregular surface.

5. A fitting structure of tray rail of an optical disc drive according to claim 1 wherein said guide pole is formed on an outer side of said base.

6. A fitting structure of tray rail of an optical disc drive according to claim 5 wherein said first inclines on guide pole are formed on both vertical surfaces of said guide pole; said second inclines on said rail are formed on interior vertical surface of said rail.

7. A fitting structure of tray rail of an optical disc drive according to claim 1 wherein said guide poles are formed on two outer sides of said base.

8. A fitting structure of tray rail of an optical disc drive according to claim 7 wherein said first inclines on guide poles are formed on outer vertical surfaces of said guide poles; said second inclines on said rails are formed on an left vertical inner surface of a left rail and a right vertical inner surface of a right rail.

9. A fitting structure of tray rail of an optical disc drive according to claim 1 wherein said guide poles with third inclines are two upside stoppers mounted on said base.

10. A fitting structure of tray rail of an optical disc drive according to claim 9 wherein said third inclines on guide poles are formed on bottom horizontal planes of said upside stoppers; said second inclines on said rails are formed on a left vertical outer surface of a left rail and a right vertical outer surface of a right rail.
